(19) United States
(12) Patent Application Publication
(10) Pub. No.: US 2017/0152829 A1
(43) Pub. Date: Jun. 1, 2017

(54) SPARK PLUG AND SOCKET

(71) Applicant: IMAGINEERING, INC., Kobe-shi, Hyogo (JP)

(72) Inventors: Yuji Ikeda, Kobe-shi (JP); Seiji Kanbara, Kobe-shi (JP)

(73) Assignee: IMAGINEERING, INC., Kobe-shi, Hyogo (JP)

(21) Appl. No.: 15/305,974

(22) PCT Filed: Apr. 22, 2014
(86) PCT No.: PCT/JP2015/062234

§ 371 Date: Jan. 6, 2017

(30) Foreign Application Priority Data
Apr. 22, 2014 (JP) 2014-088631

(51) Int. Cl. F02P 23/04; H01T 13/20; H01T 13/40; H01T 13/04

(52) U.S. Cl. CPC F02P 23/045; H01T 13/04; H01T 13/20; H01T 13/40; H05H 1/52

(57) ABSTRACT

[PROBLEMS] An ignition plug is provided, in which a tip end part of a central electrode is not eroded and an electric power loss of the electromagnetic wave can be reduced, even in a case where a configuration is performed such that a high voltage for discharge and an electromagnetic wave are supplied from a terminal part side of an ignition plug. An electrode part 2 comprises a central electrode 2A including an electrode chip part for generating the spark discharge with the ground electrode 5, and a cylindrical insulating tube member 2B for covering the central electrode 2A. On the outer peripheral surface of the insulating tube member 2B, a conductive member 21 is provided so as to electrically connect the central electrode 2A with a terminal part 20 for receiving an electric power from the outside.

### TECHNICAL FIELD

The present invention relates to an ignition plug for irradiating high voltage for spark discharge and an electromagnetic wave supplied as energy into the spark discharge, and a socket used for the ignition plug.

### BACKGROUND ART

Conventionally, the plasma generator which generates a local plasma by using the discharge of the ignition plug so as to expand the plasma by the electromagnetic wave (microwave), has been developed (for example, referring to “Patent Document 1”). In the plasma generator, the mixer including the mixing circuit for mixing the discharge current (energy for the discharge) for the spark discharge and the electromagnetic wave energy from the electromagnetic wave generator is provided, and the mixer is connected to the connection terminal part which becomes the input terminal of the ignition plug. Thereby, the high voltage (discharge current) for the spark discharge and the electromagnetic wave pass through the same transmission line (electrical path), and are supplied into the ignition plug. Therefore, the central electrode of the ignition plug is commonly used for the spark discharge electrode and the antenna for irradiating the electromagnetic wave.

However, the central electrode (in below, which is referred to “central electrode” collectively from the terminal part connected with the ignition coil to the tip end part for forming the discharge gap with the ground electrode. Same as below) of the general ignition plug used for the plasma generator normally contains alloy which is mainly composed of iron, except for the tip end. Therefore, the electromagnetic wave supplied from the electromagnetic wave oscillator flows through the surface of the central electrode; however, since iron with the high magnetic permeability is the main component and the resistance is incorporated inside, large electric power loss is accommodated, and the electromagnetic wave oscillator could not be downsized in order to perform sufficient irradiation of the electromagnetic wave.

Further, the discharge current for the spark discharge and the electromagnetic wave are commonly outputted from the tip end part of the central electrode. Therefore, the strengths of the electric field generated by the discharge current and the electromagnetic wave between the tip end of the central electrode and the ground electrode are highest at the axial center part of the central electrode.

Specifically, the strengths of the electric field generated by the discharge current and the electromagnetic wave between the tip end of the central electrode and the ground electrode are, by using the axial center of the central electrode as a symmetric axis, commonly highest at the axial center of the central electrode, and become the curve line which decreases towards the outer edge of the insulator for covering the central electrode. Therefore, the strengths of the electric filed generated by the discharge current and the electromagnetic wave are superimposed, the axial center of the central electrode becomes highest in temperature, and there has been a malfunction of which the tip end part of the central electrode is easy to erode.

Moreover, the mixer including the mixing circuit for mixing the discharge current for the spark discharge and the electromagnetic wave energy from the electromagnetic wave generator has been a main factor for increasing the cost in the whole device.

### PRIOR ART DOCUMENT

### Patent Document

Patent document 1: Japanese Unexamined Patent Application Publication No. 2009-036198

### SUMMARY OF INVENTION

### Problems to be Solved

The present invention is provided based on the above situations, and the objective provides an ignition plug in which a tip end part of a central electrode does not erode, and electric power loss of the electromagnetic wave can be reduced, even in a case of being formed so as to supply high voltage for discharge and electromagnetic wave from a terminal part side of the ignition plug, and a socket for supplying high voltage and electromagnetic wave from a supply source into the ignition plug.

### Measures for Carrying out the Invention

A first invention so as to solve the above problem is an ignition plug which comprises a terminal part configured to receive an electric power from the outside, an electrode part electrically connected with the terminal part, an insulator having a shaft hole into which the electrode part is inserted in a manner that engages with the insulator, a main fitting body arranged so as to surround the insulator, and a ground electrode extended from an end surface of the main fitting body and forming a discharge gap to generate a spark discharge between the ground electrode and the electrode part, the electrode part comprises a central electrode provided with an electrode chip part for generating a spark discharge with the ground electrode and a cylindrical insulating tube member which covers an outer circumference surface of the central electrode, and a conductive member is provided on an outer peripheral surface of the insulating tube member.

In the ignition plug of the present invention, energy (discharge current) for spark discharge flows from the terminal part through the center part of an axial center of the central electrode so as to generate the spark discharge between the tip end of the electrode chip part and the ground electrode. The electromagnetic wave having a characteristic of flowing through the surface of a material, flows through the conductive member provided on the outer peripheral surface of the insulating tube member from the terminal part, and is irradiated from the end surface of the ground electrode side of the conductive member. Therefore, the strength of the electric field by the discharge current between the tip end of the central electrode and the ground electrode is highest at the axial center of the central electrode; however, the strength of the electric field by the electromagnetic wave is highest at the outside (annular circular centering the axial center) further than the axial center of the central electrode, and the part which becomes high in temperature does not concentrate on the axial center part, and erosion of the tip end part of the central electrode can effectively be prevented. Moreover, the electromagnetic wave effectively flows through the conductive member provided on the outer peripheral surface of the insulating tube member, and electrical power loss can be suppressed to minimum. At this time, even if the conductive member and the terminal part are electrically connected, with regard to the high voltage for the spark discharge, the electric field strength is higher as the diameter of the tip end part for forming the discharge gap with the ground electrode is smaller. Since there is a characteristic of hardly occurrence of the discharge in a part of low electric field strength, the high voltage for the spark discharge does not flow through the conductive member provided on the outer peripheral surface of the insulating tube member, and there is never occurrence of the discharge with the ground electrode.

In this case, the conductive member and the terminal part can electrically be insulated. By insulating the conductive member and the terminal part electrically, flow of the high voltage for the spark discharge through the conductive member can surely be suppressed.

Further, in this case, the insulator, the insulating tube member, and the conductive member, can integrally be formed by calcining. Manufacturing process of the general insulator comprises a process of increasing the pressure to the raw material powder, a grinding process, and a calcining process. When the process of increasing the pressure is performed, a conductive cylinder being the conductive member is inserted coaxially with a press pin for forming a shaft hole to perform the process. Thereby, the insulator, the insulating tube member and the conductive member, can integrally be calcined, and a high accurate ignition plug can be manufactured.

Further, a second invention is a socket which comprises a power supply part electrically connected with the terminal part of the ignition plug, an annular antenna configured to irradiate an electromagnetic wave supplied from the outside, and the annular antenna and the conductive member are capacity-coupled via the insulator.

Since the socket of the second invention includes the power supply part for supplying the high voltage for the spark discharge and the annular antenna for supplying the electromagnetic wave by capacity-coupled with the conductive member, the electromagnetic wave can be supplied into the plasma generated by the spark discharge via the cylindrical conductive member with a simple configuration.

In this case, the power supply part can be a coil spring which comprises a low-pass filter. By being the power supply part as the low-pass filter, the electromagnetic wave supplied from the annular antenna and flowing through the conductive member, can be prevented from flowing into the ignition coil side.

Moreover, in these cases, a coaxial resonator which constitutes a choke can be provided on the power supply part side further than the annular antenna. Thereby, the electromagnetic wave which is supplied from the annular antenna and flows through the conductive member can more certainly be prevented from flowing into the ignition coil side.

Note that, as the term of the present invention, when describing conductor (central electrode, terminal part, conductive member and etc.), it means metal material such as iron, silver, copper, gold, aluminum, tungsten, molybdenum, titanium, zirconium, niobium, tantalum, bismuth, lead, tin or alloy mainly made of these (for example, stainless steel), or these composed material and etc., and when describing dielectric (tip end dielectric cylinder), it means dielectric material, ceramics which is based on such as alumina (AL₂O₃), and etc.

### Effect of the Invention

According to the present invention, even though an ignition plug is configured to supply the discharge current and the electromagnetic wave from the terminal part of the ignition plug, erosion of the tip end part of the central electrode can effectively be prevented, and electric power loss of the supplied electromagnetic wave can be reduced. Moreover, in a plasma generator which uses the ignition plug, an electromagnetic wave oscillator can be downsized, and miniaturization of the whole device and cost reduction performance can be achieved. Further, by using a socket of the present invention, total cost reduction of the device can be achieved.

### BRIEF EXPLANATION OF THE DRAWINGS

FIG. 1 illustrates an ignition plug regarding a first embodiment, (a) illustrates a partially cross-sectional view, and (b) is an elevation-sectional view which assembles a central electrode, a terminal part, and an insulating tube member.

FIG. 2 illustrates an ignition plug regarding a second embodiment, (a) illustrates a partially cross-sectional view, (b) is a partially enlarged cross-sectional view which illustrates a configuration of connecting electrically a conductive member and the terminal part, and (c) is a partially enlarged cross-sectional view which illustrates a configuration of insulating electrically the conductive member and the terminal part.

FIG. 3 illustrates an ignition plug regarding a third embodiment, (a) is a partially cross-sectional view, and (b) is a partially enlarged cross-sectional view which illustrates a configuration of calcining integrally an insulator, an insulating tube member, and a conductive member.

FIG. 4 illustrates a schematic view which illustrates a process of molding integrally the insulator, the insulating tube member, and the conductive member of the third embodiment, (a) illustrates a state of filling raw material powder inside a rubber die cavity, (b) illustrates a state of compressing and pressurizing the rubber die, (c) illustrates a state of stopping the pressure application, and (d) illustrates a state of extracting a compressed-and-molded body from the inside of the cavity.

FIG. 5 illustrates a socket of a fourth embodiment, (a) is an elevational-cross-sectional view, and (b) is a schematic view for illustrating the connection of an antenna with a cable.

### DESCRIPTION OF THE PREFERRED EMBODIMENTS

In below, embodiments of the present invention are illustrated in details, based on figures. Note that, the following embodiments are essentially desirable examples, and the scope of the present invention, the application product, or the use does not intend to be limited.

### First Embodiment

### —Ignition Plug—

The present first embodiment is an ignition plug regarding the present invention.

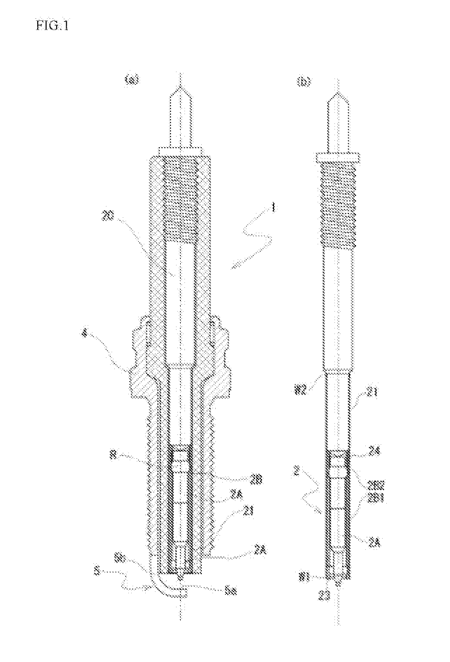

In FIG. 1, an ignition plug of the present first embodiment is illustrated. The ignition plug 1 includes a terminal part 20 for receiving an electric power from the outside, an electrode part 2 electrically connected with the terminal part 20, an insulator 3 formed with a shaft hole 30 into which the electrode part 2 and a part of the terminal part 20 connected to the electrode part 2 are engaged, a main fitting body 4 arranged so as to surround the insulator 3, and a ground electrode 5 extended from the end surface of the main fitting body 4 and forming a discharge gap at which the spark discharge occurs with a tip end part of the electrode part 2 (electrode chip part of a central electrode 2A). Further, the electrode part 2 comprises the central electrode 2A providing an electrode chip part at the tip end in order to generate the spark discharge with the ground electrode 5, and a cylindrical insulating tube member 2B which covers a part or entire of the central electrode 2A, and a conductive member 21 is provided on the outer peripheral surface of the insulating tube member 2B. Note that, in the present embodiment, one end of the terminal part 20 is protruded to the outside, and electrically connected with a secondary electrode side of the ignition coil, and a shaft-like part on the other end coming into contact with the central electrode 2A has a construction of inserting into the shaft hole 30 of the insulator 3.

In the present embodiment, the conductive member 21 provided on the outer peripheral surface of the insulating tube member 2B, is electrically connected with the terminal part 20 for receiving the electric power from the outside. Then, the high voltage for spark discharge and the electromagnetic wave supplied as energy into the spark discharge are supplied from the secondary electrode side of the ignition coil (not illustrated) and an electromagnetic wave oscillator (not illustrated) into the terminal part 20 via a mixer (not illustrated) including a mixing circuit, which prevents the high voltage (discharge current) for spark discharge and the electromagnetic wave from back-flowing into each of the supply sources. Even if the conductive member 21 and the terminal part 20 are electrically connected as the present embodiment, the spark discharge by the discharge direct current never occurs between the end part of the ground electrode side of the conductive member 21 and the ground electrode 5. This is because the high voltage for the spark discharge occurs in a point in which the discharge part area is small and the electric field is high, or in a point in which the distance from the ground electrode 5 is short. In the present embodiment, the strength of the electric field becomes low since the end part of the ground electrode side of the conductive member 21 is annular circular, and the area is larger than the central electrode 2A having a pointed head shape. Further, since the tip end part of the central electrode 2A is protruded further than the end part of the ground electrode side of the conductive member 21, with regard to the distance from the ground electrode 5, the distance from the tip end part of the central electrode 2A becomes shorter.

The insulator 3 is molded by the known method such as the hydrostatic pressure press of the alumina powder by the ceramics composed of, for example, the alumina (AL₂O₃) having the high insulation performance and the heat corrosion resistance performance, it is grinded by the grinding device, the grindstone, and etc., and then, it is calcined at the temperature before and after 1600 □ so as to manufacture the insulator 3.

The electrode chip part being the tip end part of the central electrode 2A preferably uses noble metal such as platinum alloy and iridium, which has the high-melting-point and the oxidation resistance performance.

The conductive member 21 is not especially limited, if it is the conductor made of the metal; however, material, for example, stainless, silver, copper, gold, aluminum, tungsten, molybdenum, titanium, zirconium, niobium, tantalum, bismuth, lead, tin or alloy mainly made of these (for example, stainless steel), or these composed material, or these coated material, is used. Further, the coating material (for example, titanium coating) can also be used, and the thickness is between 0.04 mm and 0.2 mm, and preferably about between 0.06 mm and 0.1 mm. Moreover, it can also be composed by coating on the outer peripheral surface of the insulating tube member 2B.

The insulating tube member 2B as well as the insulator 3, preferably uses the ceramics composed of, for example, alumina (AL₂O₃) which has the high insulation performance and the heat corrosion resistance performance.

On one end side of the terminal part 20 protruded to the outside, the power is supplied from the ignition coil, and on the other end side, it is inserted into the shaft hole 30 so as to connect to the central electrode 2A.

The main fitting body 4 is a substantially cylindrical case made of metal. The main fitting body 4 supports the outer circumference of the insulator 3 so as to accommodate the insulator 3. There exists a space between the inner peripheral surface of the tip end part of the main fitting body 4 and the outer peripheral surface of the tip end part of the insulator 3 so as to be separated. On the outer peripheral surface of the tip end side of the main fitting body 4, a male screw part 41 is formed as a structure for mounting to an internal combustion engine. The ignition plug 1 is threadly-fixed into the cylinder head by engaging the male screw part 41 of the main fitting body 4 with a female screw part (not illustrated) of the plug hole of the cylinder head. On the upper part of the main fitting body 4, a wrench fitting part 40 into which the plug wrench is engaged, is formed. Note that, powder-state talc is filled as a sealing member between the wrench fitting part 40 of the main fitting body 4 and the insulator 3 so as to caulk the end part.

The ground electrode 5 forms the discharge gap at which the spark discharge occurs with the central electrode 2. The ground electrode 5 comprises a ground electrode main body part 5b and a ground electrode chip part 5a. The ground electrode main body part 5b is a conductor of curved plate shape. One end side of the ground electrode main body part 5b is joined with the tip end surface of the main fitting body 4. The ground electrode main body part 5b extends along the axial center of the ignition plug 1 from the tip end surface of the main fitting body 4, curves substantially 90□ inwards, and the tip end side provided with the ground electrode chip part 5a faces the electrode chip part provided at the tip end of the central electrode 2A.

Assembling of the central electrode 2A, the insulating tube member 2B, the conductive member 21 and the terminal part 20 is not especially limited; however, in the present embodiment, as illustrated in FIG. 1(b), on one end (the ground electrode side) of the cylindrical conductive member 21, an engaging member 23 is jointed at a joint part W1 by performing a joint means such as blazing welding. The engaging member 23 forms an outer peripheral step portion for engaging the end part of the conductive member 21. The outer diameter of the engaging member 23, except for the step portion, is substantially same diameter as the inner diameter of the conductive member 21, and it is inserted from the end part of the ground electrode side of the conductive member 21. Then, one end of a tip end part 2B1 of the insulating tube member 2B which is divided into the tip end part 2B1 and a rear end part 2B2, comes into contact with an end part on the opposite ground electrode side of the engaging member 23, and the large diameter part of the central electrode 2A is engaged with the other end part of the tip end part 2B1. Next, the rear end part 2B2 of the insulating tube member 2B and an elastic member 24 are coaxially arranged with the central electrode 2A. The elastic member 24 uses, for example, a coil spring so as to assist the joint of the terminal part 20 with the central electrode 2A. In this state, the terminal part 20 is inserted into the conductive member 21. Then, while pushing down the elastic member 24, in the state electrically connected with the central electrode 2A, a joint means such as brazing welding is performed at a joint part W2 so as to joint. In the vicinity of the joint part of the terminal part 20 with the ignition coil, the male screw is engraved on the outer peripheral part of the shaft-like part inserted into the shaft hole 30, and the female screw is engraved at the corresponding point on the inner surface of the shaft hole 30 of the insulator 3. Then, the male screw of the terminal part 20 is engaged with the female screw of the shaft hole 30 so as to fix. Note that, by using suitably the joint means such as the ceramic adhesive without engraving the screw in the shaft hole 30 and the terminal part 20, the central electrode 2A, the insulating tube member 2B, and the terminal part 20 can also be connected to the insulator 3. After that, the insulator 3 including the central electrode 2A, the insulating tube member 2B, and the terminal part 20 is mounted to the main fitting body 4 so as to complete the ignition plug 1.

In the above configuration, regarding the ignition plug 1, the high voltage for spark discharge supplied from the terminal part 20 flows through the axial centers of the terminal part 20 and the central electrode 2A. Then, spark discharge is generated between the electrode chip part of the tip end of the central electrode 2A and the electrode chip part 5a of the ground electrode 5, specifically, at the discharge gap. Further, since the electromagnetic wave (microwave) supplied as energy into the spark discharge has a characteristic of flowing through the surfaces of the conductor and the dielectric, it flows through the surface of the terminal part 20 and the surface of the conductive member 21, and it is irradiated (supplied) with annular circular shape towards the ground electrode 5 side (combustion chamber side) from the end surface of the ground electrode side of the engaging member 23 contacted with the conductive member 21. Thereby, the irradiated electromagnetic wave is supplied as energy into the discharge plasma occurred at the discharge gap formed between the central electrode 2A and the ground electrode 5 so as to maintain and expand the plasma. Here, peak part of the electric field strength of the electromagnetic wave irradiated, is shifted from the axial center of the central electrode 2A, and deviated from the peak part of the electric field strength by the discharge current. As a result, temperature rise at the axial center part of the central electrode 2 can be prevented, and erosion of the electrode chip part being the tip end part of the central electrode 2 can effectively be prevented.

### Effect of the First Embodiment

In the ignition plug of the present embodiment, the electromagnetic wave flows through the surface of the conductive member 21 which is the cylindrical conductor, and the electromagnetic wave (microwave) is supplied as energy into the spark discharge occurring between the central electrode 2A and the ground electrode 5 so as to expand the discharge plasma. Thereby, ignition stability can be improved. As a result, an internal combustion engine using the ignition plug can perform ultra-lean combustion, and fuel consumption and the amount of emission of CO₂ can be reduced. Moreover, the discharge current for the spark discharge flows through the axial center of the central electrode 2A, and the electromagnetic wave supplied as energy into the spark discharge is emitted with annular circular shape surrounding the central electrode 2A, and therefore, with regard to each of strengths of the electric field generated by the discharge current and the electromagnetic wave between the tip end of the central electrode 2A and the ground electrode 5, the strength of the electric field by the discharge current is highest at the axial center of the central electrode 2A; however, the strength of the electric field by the electromagnetic wave is highest at the outside (annular circular surrounding the axial center) further than the axial center of the central electrode 2A, and the part which becomes high in temperature, never concentrates on the axial center part of the central electrode 2A. Thereby, the tip end of the electrode chip part which is the tip end part of the central electrode 2 can effectively be prevented from eroding.

Moreover, even if the length of normal discharge gap (distance from the central electrode to the ground electrode) is about the half (the central electrode 2A is approached to the ground electrode 5) and the discharge electric power is reduced, spark discharge can occur by assistance of the electromagnetic wave. Thereby, although output power about 8,000V, 800 mA was required, the discharge plasma can be generated at 1,000V, 5˜60 mA, and the supply power source can be downsized so as to contribute to energy saving, and electrical noise occurring when pulse discharge is generated, can significantly be reduced.

Further, the conductive member 21 can electrically insulate the terminal part 20 for receiving the electric power from the outside. By insulating electrically, when a socket as described below is used, the electromagnetic wave flows through the surface of the conductive member 21 by capacity coupling; however, the flow of the high voltage for discharge into the conductive member 21 can surely be prevented.

### Modification of the First Embodiment

In the modification of the first embodiment, resistance pattern is provided on one surface of a-thin-plate-like-body which is mainly composed of an insulator such as alumina, and metal coating which becomes the conductive is provided on the other surface to wound in tube state such that the surface performing the metal coating becomes the outer peripheral surface. Further, the central electrode 2 on one end of the opening end, and the terminal part 20 or joint member with the terminal part 20 on the other end, are jointed with the resistance pattern on the inner peripheral surface by brazing or welding and etc. Thereby, the tube state insulator constitutes the insulating tube member 2B, and the metal coating on the outer peripheral surface thereof constitutes the conductive member 21. At that time, molding is performed by cutting off the plate-like body which is a size for wounding from the large sized plate-like body in which the metal-coating is performed on one surface and a plurality of resistance patterns is performed on the other surface in advance, and thereby, significant cost reduction can be achieved, compared to the case of construction as illustrated in FIG. 1.

### Second Embodiment

### —Ignition Plug—

The present second embodiment relates to an ignition plug regarding the present invention. The ignition plug, compared to the ignition plug of the first embodiment, differentiates in the mounting structure of the central electrode 2A, the insulating tube member 2B, the conductive member 21, and the insulator 3 and the mounting structure of the terminal part 20 and the insulator 3. The explanation of the same structure as the first embodiment such as the main fitting body 4, the ground electrode 5, is omitted.

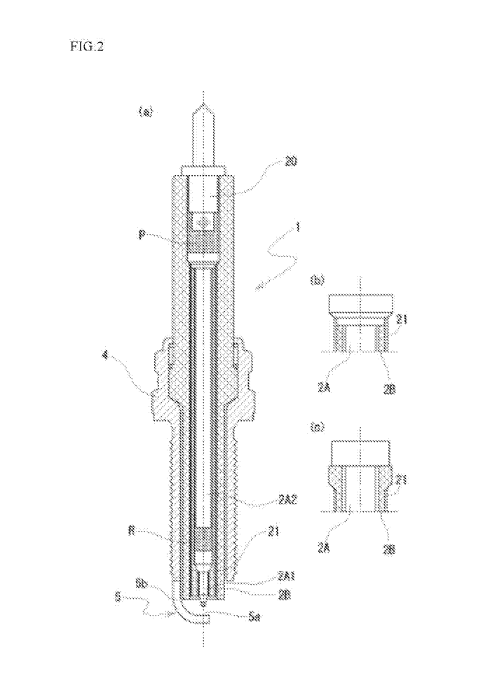

In FIG. 2, an ignition plug of the present second embodiment is illustrated. The ignition plug 1, as well as the first embodiment, includes the terminal part 20 for receiving the electric power from the outside, the electrode part 2 electrically connected to the terminal part 20, the insulator 3 formed with the shaft hole 3 into which the electrode part 2 is fitted, the main fitting body 4 arranged so as to surround the insulator 3, and the ground electrode 5 extended from the end surface of the main fitting body 4 and forming the discharge gap at which the spark discharge is generated with the tip end part of the electrode part 2 (tip end part of the central electrode 2A). The electrode part 2, as well as the first embodiment, comprises the electric chip part 2A and the insulating tube member 2B.

In the inner peripheral part of one end (the ground electrode side) of the insulating tube member 2B, a step portion for engaging the large diameter part of the central electrode 2A1 (tip end central electrode) is provided. The central electrode 2A1 comprises the electrode chip part in which the opposite electrode chip part has large diameter. While, on the outer peripheral surface, a thin cylindrical conductor which constitutes the conductive member 21, and the thickness is between 0.04 mm and 0.2 mm, preferably, about between 0.06 mm and 0.1 mm, for example, stainless steel, is fitted into. Without including the electrode chip part of the central electrode 2A, a step portion which has large diameter of the outer circumference is provided inside the insulating tube member 2B and on the end part of the central electrode 2A2 (rear end central electrode) connected with the central electrode 2A1, via powder-type-resistor R, and the step portion comes into contact with the end part of the conductive member 21. The resistor R is composed of a composite powder material (powder for composing resistor) which mixes glass powder with metal powder or carbon powder, and is sealed at the temperature (from 900□ to 1000□) higher than the glass softening temperature so as to form the insulating tube member 2B, the central electrode 2A (the central electrode 2A1 and the central electrode 2A2), and the conductive member 21 integrally.

The insulating tube member 2B, the central electrode 2A, and the conductive member 21 integrally-formed, engage the step portion formed on the end part of the central electrode 2A2 with the step portion formed inside the shaft hole 30 of the insulator 3. After that, the terminal part 20 is inserted from the opposite ground electrode side of the insulator 3. At that time, powder P (conductive mixing powder) is interposed between the end surfaces of which the central electrode 2A and the terminal part 20 face, and sealed at the temperature (from 900□ to 1000□) higher than the temperature of the glass softening temperature. The powder P (conductive mixing powder) adds the conductive glass powder to copper/tungsten-mixed-powder, chromium/nickel-mixed-powder, or titanium/nickel-mixed-powder. Further, as substitute for the conductive mixing powder, the above powder for composing resistor can also be used. Thereby, the insulator 3 into which the insulating tube member 2B, the central electrode 2A, the conductive member 21, and the terminal part 20 are incorporated, is formed, and then, the insulator 3 is mounted to the main fitting body 4 so as to complete the ignition plug 1.

Moreover, as illustrated in FIG. 2(c), the conductive member 21 and the central electrode 2A2 can electrically be insulated. By insulating electrically, when a below socket is used, the electromagnetic wave flows through the surface of the conductive member 21 by the capacitive coupling; however, the flow of the high voltage for discharge into the conductive member 21 can surely be prevented.

According to the above configuration, in the ignition plug 1, as well as the first embodiment, the high voltage for spark discharge supplied from the terminal part 20 flows through the axial centers of the terminal part 20 and the central electrode 2A, and the spark discharge is generated between the electrode chip part on the tip end of the central electrode 2A and the electrode chip part 5a of the ground electrode 5, specifically, at the discharge gap. Then, since the electromagnetic wave (microwave) supplied as energy into the spark discharge, has a characteristic of flowing through the surfaces of the conductor and the dielectric, it flows through the surface of the terminal part 20 and the surface of the conductive member 21, and is irradiated towards the ground electrode 5 side (combustion chamber side) from the end surface of the ground electrode side of the conductive member 21 with an annular circular shape. Thereby, the irradiated electromagnetic wave is supplied as energy into the discharge plasma which occurs at the discharge gap formed between the central electrode 2A and the ground electrode 5, and the plasma is maintained and expanded. Here, the peak part of the electric field strength of the irradiated electromagnetic wave is shifted from the axial center of the central electrode 2A, and deviated from the peak part of the strength of the electric field by the discharge current. As a result, temperature rise at the axial center part of the central electrode 2A can be prevented, and erosion of the electrode chip part which is the tip end part of the central electrode 2 can effectively be prevented.

### Effect of Second Embodiment

In the ignition plug of the present embodiment, as well as the first embodiment, with regard to the strengths of the electric field generated by the discharge current and the electromagnetic wave, the strength of the electric field by the discharge current is highest at the axial center of the central electrode 2; however, the strength of the electric field by the electromagnetic wave is highest at the outside (annular circular centering the axial center) further than the axial center of the central electrode 2. Further, the part which becomes high in temperature never concentrates on the axial center part of the central electrode 2, and erosion of the tip end of the electrode chip part 5a which is the tip end part of the central electrode 2 can effectively be prevented. Further, since each member is manufactured by sealing by using the composition mixing powder or powder for composing resistor, gas generated in the combustion chamber does not leak to outside from the inside of the plug when mounted to the internal combustion engine, and stabilized use can be achieved. Further, since the resistor can easily be constructed inside the plug, noise which affects electronic equipments of an automobile and occurs on the spark discharge can effectively be prevented (electrical noise prevention).

### Third Embodiment

### —Ignition Plug—

The present third embodiment relates to an ignition plug of the present invention. In the ignition plug 1, as well as the ignition plug of the second embodiment, the mounting structure of the central electrode 2A, the insulating tube member 2B, the conductive member 21, and the insulator 3 mutually (molding method in the present embodiment) and the mounting structure of the terminal part 20 and the insulator 3 (molding method) are different, compared to the ignition plug of the first embodiment. The explanation of the structure same as the first embodiment such as the main fitting body 4, the ground electrode 5, is omitted.

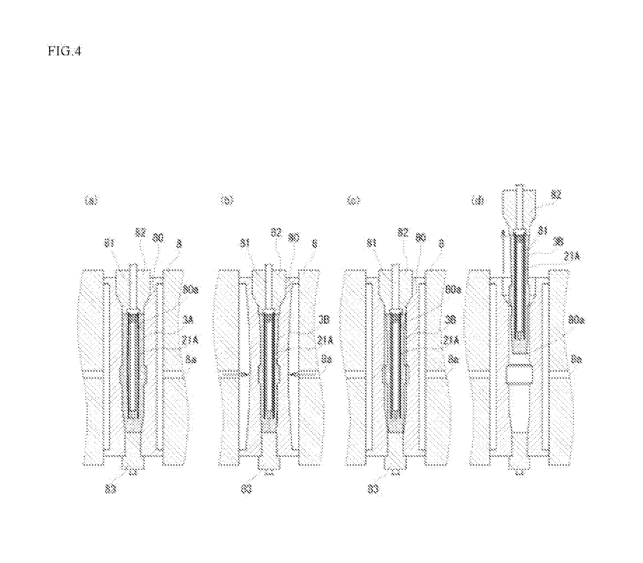

The insulator 3 of the present embodiment is formed by calcining integrally the insulating tube member 2B and the conductive member 21. Specifically, the molding of the insulator 3 is performed by using a cold isostatic press method, for example, called for “rubber press method”, as illustrated in FIG. 4.

First, raw material powder 3A which is mainly composed of alumina (AL₂O₃) and etc. is filled inside a cavity 80a formed by a rubber die 80, and a press pin 81 attached to an upper opening 81 is provided from an opening end(referring to FIG. 4(a)). Then, pressure from 30 Mpa to 100 Mpa is applied to the rubber die 80 from a fluid passage 8a of a molding device main body 8, and a molded body 3B is formed by pressurizing and compressing the raw material powder 3A (referring to FIG. 4(b)).

Next, the pressure application from the fluid passage 8a for increasing the pressure is released, the rubber die 80 is elastically restored, and the cavity 80a is restored to the original volume. Thereby, a space is formed between the compressed-molded-body 3B and the cavity 80a (referring to FIG. 4(c)). After that, the molded body 3B as well as the press pin 81 is removed from the molding device main body 8 towards the arrow direction (referring to FIG. 4(d)).

In the above process, when the press pin is inserted, the tubular conductive cylinder 21A (the conductive member 21) is arranged on the upper opening 81 so as to become concentric with the press pin 81. Thereby, the insulator 3, the insulating tube member 2B, and the conductive member 21 can be molded integrally.

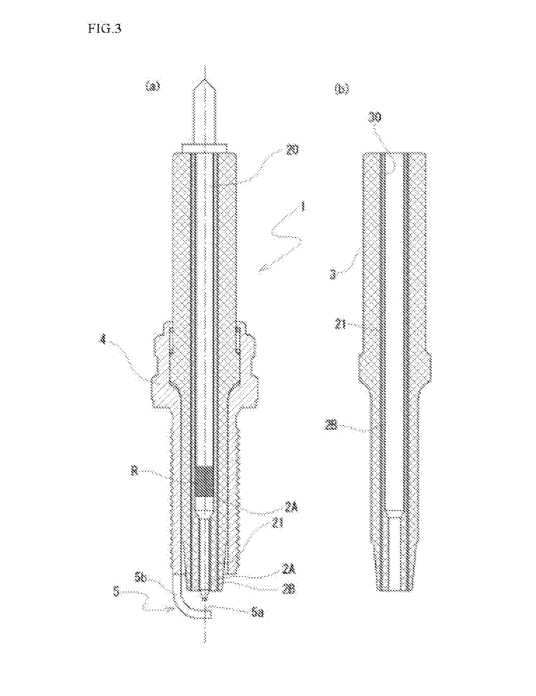

Note that, the conductive cylinder 21A is engaged into a groove portion formed in a flange part of the press pin 81 to easily-attachable-and-detachable-degree, and a coaxial state is maintained. Moreover, the pressure is equally applied on the surface of the conductive cylinder 21A such that the conductive cylinder 21A becomes cylindrical shape when it is deformed in shape by the pressure application, and for example, the shape is preferably concaved, the center part swells before pressurized such that it becomes, after pressurized, the straight cylindrical shape. After that, only the press pin 81 is removed with the conductive cylinder 21A remained, a support pin is inserted in order that the outline part is molded to a desirable shape, i.e., grinding is performed, and after the grinding, calcination is performed. Thereby, the insulator 3, the insulating tube member 2B (the insulating tube member 2B is a part of the insulator 3.), and the conductive member 21 are formed by calcining integrally, as illustrated in FIG. 3(b).

The press pin 81 has a configuration with step, and the tip end part has small diameter such that the stepped portion for engaging the large diameter part of the central electrode (tip end central electrode) is formed. The central electrode comprises the electrode chip part in which the opposite electrode chip part becomes large diameter.

When the conductive member 21 electrically insulates the terminal part 20 for receiving the electric power from the outside, an insulating washer is interposed between a flange part 20a of the terminal part 20 illustrated in FIG. 3(a) and the end surface of the conductive member 21. By insulating electrically, when a below socket is used, the electromagnetic wave flows through the surface of the conductive member 21 by capacity coupling; however, flow of the high voltage for discharge into the conductive member 21 can surely be prevented.

According to the above configuration, in the ignition plug 1, as well as the first embodiment and the second embodiment, high voltage for the spark discharge supplied from the terminal part 20 flows through the axial centers of the terminal part 20 and the central electrode 2A, and the spark discharge is generated between the electrode chip part of the tip end of the central electrode 2A and the electrode chip part 5a of the ground electrode 5, specifically, at the discharge gap. Further, since the electromagnetic wave (microwave) supplied as energy into the spark discharge has a characteristic of flowing through the surfaces of the conductor and the dielectric, the electromagnetic wave (microwave) flows through the surface of the terminal part 20 and the surface of the conductive member 21, and is irradiated from the end surface of the ground electrode side of the conductive member 21 towards the ground electrode 5 side (combustion chamber side) with annular circular shape. Thereby, the irradiated electromagnetic wave is supplied as energy into the discharge plasma occurring at the discharge gap formed between the central electrode 2A and the ground electrode 5, and the plasma is maintained and expanded. Here, the peak part of the electric field strength of the irradiated electromagnetic wave is shifted from the axial center of the central electrode 2A, and deviated from the peak part of the strength of the electric field by the discharge current. As a result, temperature rise at the axial center part of the central electrode 2 is prevented, and erosion of the electrode chip part which is the tip end part of the central electrode 2 can effectively be prevented.

### Effect of Third Embodiment

The ignition plug of the present embodiment can be manufactured by the same process with the manufacturing method of the insulator for the ignition plug which is normally used, and initial cost for new capital investment and etc., can be reduced. Further, as well as the second embodiment, since each member is manufactured by sealing by using the composition powder material or powder for composing resistor, gas generated in the combustion chamber never leaks from the inside of the plug to the outside when mounted to the internal combustion engine, and stabilized use can be achieved. Further, since the resistor can easily be constructed inside the plug, noise which affects electronic equipments of an automobile and occurs on the spark discharge can effectively be prevented (electrical noise prevention).

### Modification of Third Embodiment

In the modification of third embodiment, the press pin 81 used when molding by the rubber press method, can be used as it is, as the connecting part and the central electrode. In this case, the tip end of the press pin 81 preferably has the length which reaches the below opening 83.

Further, the shaft part of the press pin 81 can also be the central electrode with resistance, which is formed by jointing such as brazing or welding, the resistance pattern on the surface of a cube which is mainly composed of an insulator such as alumina and the bottom surface is a regular polygon shape (preferably, a regular tetragon), the central electrode 2 on one end of the resistance pattern, and the terminal part 20 or the jointing part with the terminal part 20 on the other end. Thereby, the central electrode and the resistor can easily be constructed. Moreover, the shaft part of the press pin 81 is formed by cutting off from the large sized plate-like body in which a plurality of resistance patterns is provided on the surface in advance, and thereby, manufacturing cost can significantly be reduced.

### Fourth Embodiment

### —Socket for Ignition Plug—

A socket 100 for ignition plug in the present embodiment is a socket device for ignition plug which is mounted attachably-and-detachably to the ignition plug 1 regarding the first through third embodiments provided in the cylinder head of the internal combustion engine, or a socket device integrated with ignition coil, jointing part with the ignition plug, and includes one which is connected from the ignition coil to the ignition plug 1 via distributer, and one which is integrated with the ignition coil and connected to the ignition plug 1.

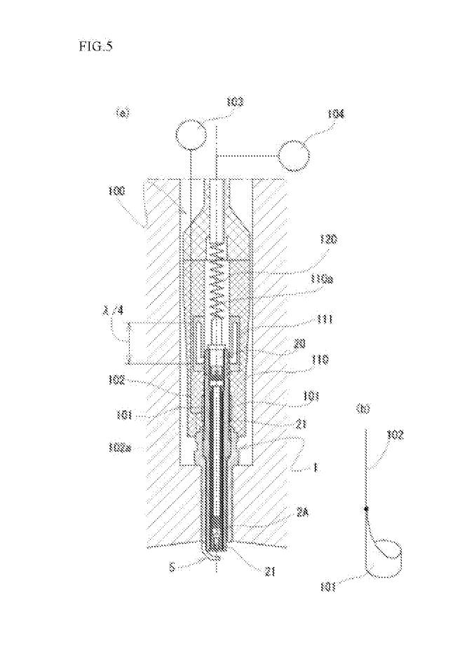

The socket 100, as illustrated in FIG. 5, comprises a socket main body 110, a power supply part 120 provided inside the socket main body 110, an annular antenna 101 for irradiating an electromagnetic wave, a cable 102 (for example, coaxial cable) for supplying the electromagnetic wave oscillated from an electromagnetic wave oscillator 103 into the antenna 101.

The socket main body 110 is formed in cylindrical shape, and an inserting hole 110a is formed inside. The socket main body 110, especially, the joint part with the ignition plug 1, is composed of an elastic member which can elastically be deformed, for example, elastically deformable rubber, and etc.

The power supply part 120 is not especially limited, if it has a configuration which electrically connects the terminal part 20 protruding from the ignition plug 1 with the secondary coil side of the ignition coil; however, in the present embodiment, a spring is used so as not to be cut off caused by a slight deviation of the socket 100. In below, the power supply part 120 may refer to a conductive spring 120. Thanks to the power supply part 120 being a spring, the power supply part 120 comprises a low-pass filter, and the electromagnetic wave irradiated from the antenna 101 can be prevented from leaking to the side of the ignition coil 104 connected to the power source for discharge.

An arranging position of the antenna 101 is not especially limited; however, the antenna 101 is arranged on the inner peripheral surface of the inserting hole 110a of the socket main body 110 such that the position of the conductive member 21 inside the ignition plug 1 corresponds to the position in the axial direction, when the socket 100 is mounted to the ignition plug 1. Further, if the cable 102 for supplying the electromagnetic wave into the antenna 101 is a coaxial cable, a grounding 102a jointed with the main fitting body 4 of the ignition plug is provided. The contacting point of the grounding 102a with the main fitting body 4 is comprised of an elastic member such as a spring, and preferably configured so as not to be cut off caused of a slight deviation of the socket 100. If the grounding 102a is connected at a reference electrical potential point, it may not be connected to the main fitting body 4, and may be connected to, for example, the cylinder head of the internal combustion engine.

The cable 102 may be wired from the outer peripheral surface of the socket main body 110 corresponding to the arranging position of the antenna 101 to the outside of the socket main body 110; however, as illustrated in FIG. 5(a), by configuring so as to embed inside the socket main body 110, it never rubs to the peripheral surface of the plug-mounted-hole of the cylinder head, and breakage or abrasion can be suppressed.

Regarding connection of the antenna 101 and the cable 102, as illustrated in FIG. 5(a), the antenna 101 can be formed cylindrically, and the cable 102 can be connected with any peripheral surface of the antenna 101; however, as illustrated in FIG. 5(b), a part of the peripheral surface of the antenna 101 is preferably extended in the axial direction such that the circular arc length decreases gradually, and preferably formed so as to connect with the apex portion. By such a connection, reflection of the electromagnetic wave at the joint point of the cable 102 with the antenna 101 can be suppressed.

Further, the antenna 101 can be composed by wounding the cable 102 much on the outer peripheral surface in the vicinity of the opening end of the socket main body 110. If the cable 102 is a coaxial cable, the central inner conductor (copper wire) is wounded. Moreover, the copper wire may be woven into the outer peripheral surface or into the inner peripheral surface of the socket main body 110 in advance so as to compose the antenna 101, and the socket main body 110 may be molded.

Arrangement of a coaxial resonator 111 constituting a choke on the ignition coil side further than the antenna 101 is preferably performed in the inner peripheral surface of the inserting hole 110a of the socket main body 110. This coaxial resonator 111 is, as illustrated in FIG. 5(a), a conductor, cylindrical body of which the inner diameter is substantially similar to the inserting hole 110a, a cavity is formed inside, the cross-section is L-character shape, and the length of the cavity in the axial direction is configured so as to be λ/4 with regard to the frequency λ of the supplied electromagnetic wave. Then, entering of the electromagnetic wave from the opening part is to be permitted. Thereby, the electromagnetic wave irradiated from the antenna 101 can surely be prevented from leaking to the side of the ignition coil 104 connected to the power source for discharge.

Further, the used ignition plug 1 of the first through third embodiments is preferably insulated with the cylindrical conductive member 21 and the terminal part 20. As above mentioned, even if the conductive member 21 and the terminal part 20 are electrically connected, the end part of the ground electrode side of the conductive member 21 is separated further from the ground electrode than the end part of the ground electrode side (electrode chip part) of the central electrode 2A, and the area of the end part of the central electrode 2A is smaller, compared to that of the conductive member 21. Therefore, the high voltage for discharge never generates the dielectric breakdown between the conductive member 21 and the ground electrode 5; however, by insulating between the conductive member 21 and the terminal part 20, flow of the high voltage through the conductive member 21 can surely be prevented.

In the above configuration, the high voltage for discharge receives an ignition signal from the controller (in the internal combustion engine, for example, ECU), and flows from the secondary electrode side of the ignition coil 104 into the terminal part 20 of the ignition plug 1 via the spring-type-power-supply-part 120. Moreover, the spark discharge is generated at the discharge gap formed between the electrode chip part of the central electrode 2A and the electrode chip part 5a of the ground electrode 5.

Further, the electromagnetic wave (microwave) supplied as energy into the spark discharge is irradiated from the antenna 101 via the cable 102 starting at the electromagnetic wave oscillator 103. Since the annular antenna 101 and the tubular-type conductive member 21 are capacity-coupled, the supplied electromagnetic wave flows through the surface of the conductive member 21, and is emitted from the end surface of the ground electrode side of the conductive member 21, with annular circular shape so as to surround the axial center of the central electrode 2A. Further, temperature rise at the axial center part of the central electrode 2 is prevented.

### Effect of Fourth Embodiment

The socket of the present embodiment has a configuration which improves the socket device for the ignition plug normally-used, or the socket device integrally with the ignition coil, the joint part with the ignition plug, and therefore, manufacturing cost can be suppressed. Further, since the cylindrical conductive member of the ignition plug and the tubular-type antenna are capacity-coupled so as to provide, inside the socket, the coil spring comprising the low-pass filter and the coaxial resonator constituting the choke, the mixer including the mixing circuit is not required.

### First Modification of the Fourth Embodiment

In the first modification of the fourth embodiment, a cylindrical conductor which is to be an antenna is formed on the surface of the insulator 3 of the ignition plug of the first through third embodiments. Then, the tip end of the cable 102 and the antenna on the surface of the insulator 3 are configured to be electrically connected. At that time, since the electrical connection with the antenna is surely performed, the tip end of the cable 102 is connected to a substantially ring-shape member which has slightly smaller diameter than the outer diameter of the insulator 3, and when the socket 100 is mounted to the ignition plug 1, the ring-shape member is preferably composed so as to elastically deform (so as to reduce the diameter).

### INDUSTRIAL APPLICABILITY

As explained as above, according to the present invention, the high voltage for the spark discharge flows through the center of the central electrode, and the electromagnetic wave (microwave) supplied as energy into the spark discharge is emitted from the end surface of the ground electrode side of the conductive member with the annular circular shape so as to surround the axial center of the central electrode. Then, the temperature rise at the axial center part of the central electrode can be prevented, and the electrical loss can significantly be reduced, and therefore, suitable use for a plasma generator which supplies the discharge voltage for the spark discharge and the microwave as energy into the spark discharge, can be achieved. As these results, wide use for automobile, airplane, ship and etc., as the internal combustion engine such as engine for automobile which uses the ignition plug and the socket of the present invention, can be achieved. Further, the use for kinds of internal combustion engines such as gasoline engine, diesel engine, and natural gas engine as internal combustion engine, can be achieved.

Further, the socket of the fourth embodiment can use the normal ignition plug except for the ignition plug illustrated in the first through third embodiments. In this case, the capacity-coupling with the shaft-like part inside the insulator 3 of the terminal part for receiving the electric power from the outside is performed via the insulator 3. In other words, the electromagnetic wave supplied by capacity-coupling of the annular antenna 101 with the conductor (inside conductor) arranged inside the ignition plug, is to be supplied from the tip end of the ignition plug into the combustion chamber. In case of a general ignition plug with resistance, compared to the case where the capacity-coupling with the cylindrical conductive member 21 is performed, the flow of the supplied electromagnetic wave is worse; however, a cheap normal ignition plug can be used. Moreover, when the plug without resistance is used, the electromagnetic wave (microwave) concentrates on the center compared to the ignition plug illustrated in the first through third embodiments; however, sufficient microwave can be supplied into the inside of the combustion chamber.

### EXPLANATION OF REFERENCES

1. Ignition Plug
2. Electrode Part
2A Central Electrode
2B Insulating Tube Member
20 Terminal Part
21 Conductive Member
3 Insulator
30 Shaft hole
4 Main Fitting Body
5Ground Electrode
5a Ground Electrode Chip Part
5b Ground Electrode Main Body Part
100 Socket
101 Antenna
102 Cable
110 Socket Main Body
120 Power-supply Part (Power-supply Spring)

1. An ignition plug comprising:
a terminal part configured to receive an electric power from the outside;
an electrode part electrically connected with the terminal part;
an insulator having a shaft hole into which the electrode part is inserted in a manner that engages with the insulator;
a main fitting body arranged so as to surround the insulator; and
a ground electrode extended from an end surface of the main fitting body and forming a discharge gap to generate a spark discharge between the ground electrode and the electrode part, and
wherein the electrode part comprises,
a central electrode provided with an electrode chip part for generating the spark discharge with the ground electrode, and
a cylindrical insulating tube member which covers an outer circumference surface of the central electrode, and
wherein a conductive member is provided on an outer peripheral surface of the insulating tube member.

2. The ignition plug according to claim 1,
wherein the conductive member is electrically insulated from the terminal part.

3. The ignition plug according to claim 1,
wherein the insulator, the insulating tube member, and the conductive member are formed integrally by calcining.

4. A socket to be mounted to an ignition plug according to claim 1, comprising:
a power supply part electrically connected with the terminal part of the ignition plug; and
an annular antenna configured to irradiate an electromagnetic wave supplied from the outside, and
wherein the annular antenna and the conductive member are capacity-coupled via the insulator.

5. The socket according to claim 4,
wherein the power supply part is a coil spring which comprises a low-pass filter.

6. The socket according to claim 4, further comprising:
a coaxial resonator which constitutes a choke on an ignition coil side further than the annular antenna.
